(19) United States
(12) Patent Application Publication
(10) Pub. No.: US 2015/0160032 A1
(43) Pub. Date: Jun. 11, 2015

(54) VEHICULAR NAVIGATION SYSTEM

(71) Applicant: Kyungpool National University Industry-Academic Cooperation Foundation, Buk-gu (KR)

(72) Inventors: Dong Seog HAN, Suseong-gu (KR); Kwang Hee LEE, Dalseo-gu (KR)

(21) Appl. No.: 14/558,891

(22) Filed: Dec. 3, 2014

(30) Foreign Application Priority Data
Dec. 11, 2013 (KR) 10-2013-0154176

(51) Int. Cl. G01C 21/36

(52) U.S. Cl. CPC G01C 21/3605

(57) ABSTRACT

The present invention relates to a vehicle navigation system which senses pavement signs of arrow shape which indicates direction of a lane through a sensor in regards to route guidance to a destination, set by the driver and helps the driver to recognize accurate route and receive guidance by outputting warning message for the driver in the case of discrepancy between pavement signs and a suggested route to a destination and currently traveling road information.

### CROSS-REFERENCE TO RELATED APPLICATIONS

This application claims priority from Korean Patent Application No. 10-2013-0154176, filed on Dec. 11, 2013 in the Korean Intellectual Property Office, the disclosure of which is incorporated herein by reference in its entirety.

### BACKGROUND

1. Field of the Invention

The present invention relates to a vehicular navigation system wherein configured to guide a vehicular to destination and more particularly, warns the driver in case of discrepancy in information between pavement signs on road and navigation information wherein a navigation system is currently providing.

2. Description of the Related Art

General navigation system locates current position of a traveling vehicle then, gives geographical information of located current position and traveling information of vehicle or receives a destination from the user, then conducts a search for a traveling route from current location of the vehicle to the user's desired destination thereby, suggests a driving route for the user.

Generally GPS coordinates are used for locating a vehicle's current location. GPS coordinates and destination coordinates, received from the user, map information which is stored in a navigation device and, traffic information database are generally used in route guidance to a destination.

However, conventional method of navigation system uses stored map information and traffic information, so if navigation information is not regularly updated, it may not coincide with information regarding road, the user is currently traveling or may suggest a wrong route to the driver, thereby causing confusion and problems.

Moreover, determining whether a lane, the driver is currently traveling is a preferable lane or not, can be difficult.

Thus, necessity of a navigation device which accurately gives information regarding respective traveling routes and which accurately guides routes to a destination is increasing.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

In an effort to overcome the recited problem of conventional art, it is an object to provide a vehicular navigation system wherein improves problem of the difficulty in determining whether the lane which the driver is currently driving is a preferable lane or not.

The present invention provides a vehicular navigation system wherein comprises a sensor module wherein configured in a vehicle to sense pavement signs of arrow shape which display direction of a road lane which a vehicular is driving; an input module wherein configured to receive destination from the driver; information receiver wherein configured to receive information of pavement signs sensed by the sensor module; a navigation information provision module wherein configured to provide route guidance to the destination and road information of currently traveling road which are received by the input module; a traffic information comparison determination module wherein configured to determine accordance between two traffic information of pavement signs which is sensed by the sensor module and route guidance to a destination of a vehicle which was provided by a navigation information provision module; and a warning module wherein configured to output a warning message through receiving a control signal from the traffic information comparison determination module in a case of information discrepancy.

The sensor module may comprise at least one sensor among a camera sensor, an infrared light sensor and a light sensor wherein configured to sense pavement signs of arrow shape which display lane direction.

The input module can be configured of a touch screen or button type structure which receives destination from the driver.

The information receiver module may have an additional function wherein configured to update navigation information by communicating with a traffic information server.

The navigation information provision module may have a function configured to receive location of a vehicle and navigation information which includes map information and traffic information database.

The warning module may include a display and a speaker configured to output a warning message when receiving a control signal from a traffic information comparison determination module.

The warning message can be characterized by one or more than two among a warning notice in voice, a warning screen in display and a warning alarm.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram of a vehicular navigation system according to the embodiment of the present invention.

FIG. 2 is a flow chart relating to an activation method of a vehicular navigation system according to the embodiment of the present invention and,

FIG. 3 is a schematic view of a vehicular navigation system according to the embodiment of the present invention.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

While the expressions such as “first” or “second” can be used to refer to various elements, the elements are not limited by the expressions. The expressions are used only for the purpose of distinguishing one element from the other.

The expressions are used herein only for the purpose of explaining specific embodiments and not to limit the present invention. An expression in singular form encompasses plural meaning, unless otherwise specified. Throughout the description, the expression “comprise” or “have” is used only to designate the existence of characteristic, number, step, operation, element, component or a combination thereof which are described herein, but not to preclude possibility of existence of one or more of the other characteristics, numbers, steps, operations, elements, components or combinations of these or addition.

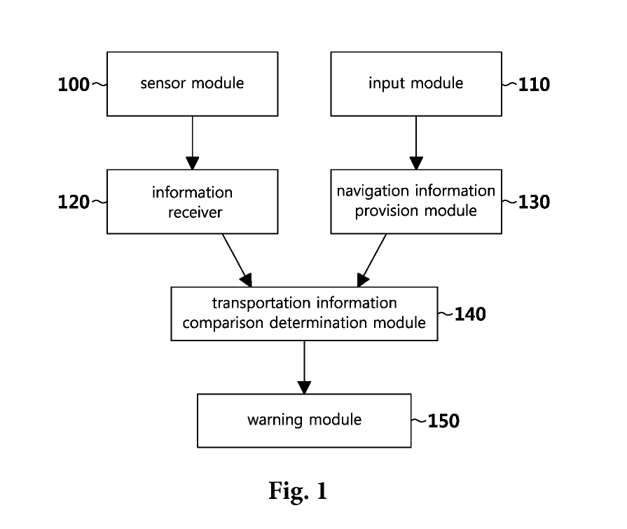

FIG. 1 is a block diagram of a vehicular navigation system according to the present invention.

A vehicular navigation system according to the present invention of FIG. 1, comprises a sensor module 100; an input module 110; an information receiver 120; a navigation information provision module 130; a traffic information comparison determination module 140; and a warning module 150.

A sensor module 100, equipped in a vehicle, is configured to sense pavement signs on a road which a vehicle is traveling. Thereby, a sensor module 100 may comprise at least one sensor such as a camera sensor, an infrared ray sensor and a light sensor configured and so on to sense pavement signs on road. Moreover, a sensor module 100 may include hardwired or wireless transmitter to transmit sensed pavement signs.

Input module 100 may comprise in a touch screen or in a button type structure to receive a desired destination from the user.

Information receiver 120 receives pavement signs transmitted from a sensor module 100 via hardwired and wireless receiver and transmits received pavement signs to the traffic information comparison determination module 140.

The information receiver 120 transmits pavement sign information and may also include a function which updates navigation information by communicating with a traffic information server as well as a function which transmits pavement signs. Update function, herein, may store new map information and road information database by communicating with traffic information server and requesting information confirmation and update in the case of discrepancy between sensed pavement signs on road and navigation information.

Navigation information provision module 130 stores map information and traffic information database and locates current position of a vehicle through received destination information from location information of vehicle and input module 110 and, gives route guidance to a desired destination and traffic information the driver is currently traveling.

GPS (Global Positioning System) coordinates can be an example of information of location of a vehicle. GPS is a method that computes current location by receiving GPS signal from at least two GPS satellites and by measuring arrival time of GPS signals. Receiving current location of a vehicle is not limited to GPS coordinates but also includes various methods such computing location using base station and visible light communication.

A traffic information comparison determination module 140 generates a control signal configured to output a warning message in the case of discrepancy between two information between pavement signs wherein transmitted from the information receiver module 120 and suggested route to the destination wherein transmitted from the navigation information provision module 130.

The warning module 150 outputs a warning message when it receives a control signal form the traffic information comparison determination module 140 and may include a display and a speaker to output a warning message.

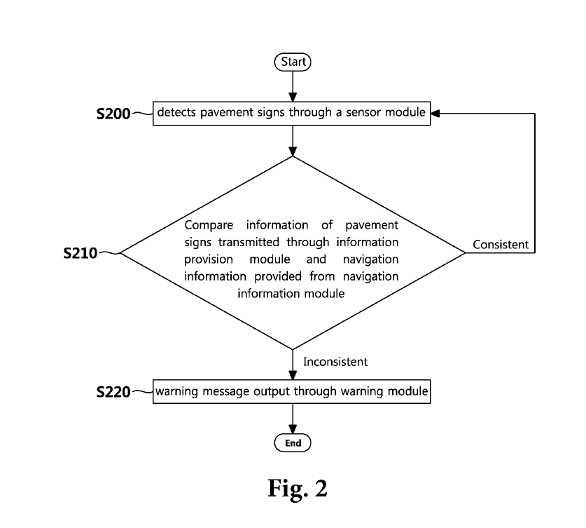

FIG. 2 is a flow chart relating to activation method of a vehicular navigation system.

First, a vehicular navigation system detects pavement signs through a sensor module 100 while traveling S200. Pavement signs on road, herein, may include display of warning/regulation/instruction signs relating to road traffic of traffic laws such as pavement signs of arrow shape which indicates direction of a road lane, no-enter pavement sign in a combination of an arrow and a X and a pavement sign regarding speed limit comprising a number.

Detected pavement signs are transmitted to a traffic information comparison determination module 140 through hardwired and wireless transmitter of a sensor module 100. Traffic information comparison determination module 140 first determines lane direction of a currently traveling vehicle from detected pavement signs such as left turn, straight, right turn, U-turn, straight and left turn, straight and right turn, left turn and U-turn. Based on determined pavement signs, when there is a discrepancy between a traveling lane and a route to destination given by navigation information provision module 130, the vehicle is not traveling the suitable lane with respect to the currently suggested route. Thus, a control signal which outputs a warning message is generated and is transmitted to a warning module 150.

A warning module 150 can warn the driver with an output of combination of one or more among voice warning using a speaker and a display, screen warning using a display, and a warning alarm when a control signal configured to output warning message is received S220.

The driver can determine whether the vehicle is currently traveling is a suitable lane or not in order to arrive at the destination the driver has set, and can receive accurate route guidance to the destination by altering lanes according to a warning.

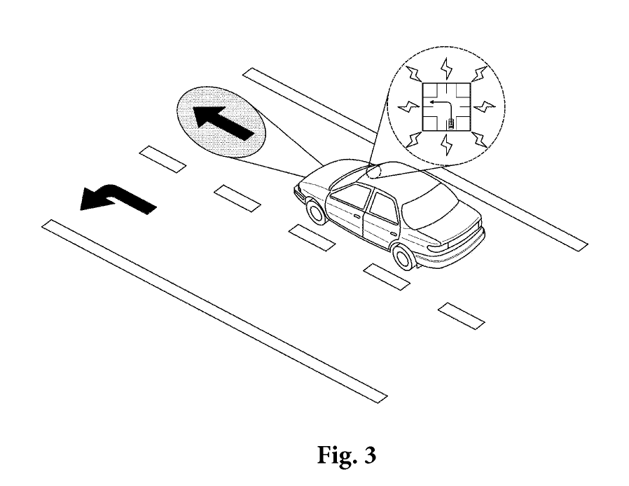

FIG. 3 is a schematic view regarding activation of a vehicular navigation system according to the embodiment of the present invention.

In FIG. 3, the driver sets a destination and is traveling a vehicle according to a route suggested by a navigation device and a traveling lane of a vehicle, the current driver is driving a straight lane. A sensor module 100 detects pavement signs of arrow shape which indicates the direction of currently traveling lane is straight by using a sensor configured to sense pavement signs. A sensor module 100 transmits pavement signs of currently sensed lane to a traffic information comparison determination module 140 then, a traffic information comparison determination module 140 determines whether the current vehicle is traveling a straight line based on the transmitted information.

Furthermore, a navigation information provision module 130 generates a traveling route to a destination which is inputted through an input module 110 and suggests the traveling route to the driver. FIG. 3, herein, illustrates route to destination displayed on navigation device wherein guides a vehicle to make a left turn at the next intersection. A navigation information provision module 130 transmits route information to traffic information comparison determination module 140 to make a left turn at the next intersection.

Traffic information comparison determination module 140 compares pavement signs detected by a sensor module 100 and navigation information provided by navigation information provision module 130. FIG. 3, herein, illustrates the traffic information comparison determination module 140 configured to compare pavement signs (arrow signs of straight direction) detected via the sensor module 100 and route guidance information (route of left turn direction) transmitted from the navigation information provision module 130.

Result of comparison shows discrepancy between pavement signs and navigation information so a traffic information comparison determination module 140 generates a control signal and transmits to a warning module 150 to warn the driver. A warning module 150 receives a control signal from a traffic information comparison determination module 140, and warns the driver in combination of one or more of warning messages using voice, warning on screen via display, and warning alarm thereby, helps the driver to acknowledge if traveling on a wrong lane and helps to alter lanes.

The embodiment it not limited to the embodiment of FIG. 3 but is identically applied on a case of a vehicle traveling 3 lanes and 4 lanes and can further include not only a warning for the driver but also guidance to alter to left lane or right lane, using traffic information of traveling road provided by a navigation information provision module 130.

A vehicle navigation system according to the present invention comprising as said, can improve accuracy of a traveling route guidance of a navigation system and convenience of the driver by suggesting a more accurate route and traveling lane through determination by comparing navigation information and pavement signs on road the current vehicle is traveling.

The preferred embodiments of the invention have been explained so far. a person skilled in the art will understand that the invention may be implemented in modifications without departing from the basic characteristics of the invention. Accordingly, the foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims.

What is claimed is:

1. A vehicle navigation system wherein comprises;
a sensor module wherein configured to sense pavement signs of arrow shape which displays direction of a road lane, a vehicular is traveling;
an input module wherein configured to receive destination from the driver;
an information receiver wherein configured to receive information of pavement signs sensed by the sensor module;
a navigation information provision module wherein configured to provide route guidance to destination and road information of currently traveling road which are inputted by the input module;
a traffic information comparison determination module wherein configured to determine accordance between two traffic information of pavement signs which is sensed by the sensor module and route guidance to the destination of a vehicle which was provided by the navigation information provision module;
and a warning module wherein configured to output a warning message by receiving a control signal from the traffic information comparison determination module in the case of information discrepancy.

2. A vehicle navigation system of claim 1 comprises;
the sensor module which comprises at least one sensor wherein configured to sense pavement sign of arrow shape which displays lane direction of a road such as camera sensor, infrared light sensor and light sensor.

3. A vehicle navigation system of claim 1 comprises;
the input module which comprises a touch screen or a button type structure configured to receive destination from the driver.

4. A vehicle navigation system of claim 1 comprises;
the information receiver module which has an additional function wherein configured to update navigation information by communicating with a traffic information server.

5. A vehicle navigation system of claim 1 comprising;
the navigation information provision module which can be characterized by receiving information of location of a vehicle and storing navigation information which includes map information and traffic information database.

6. A vehicle navigation system of claim 1 comprising;
the warning module which can be characterized by including a display configured to output a warning message using a screen and a speaker configured to output a sound.

7. A vehicle navigation system of claim 1 comprising;
the warning message wherein is characterized by one or more than two combination of warning notice with voice, warning on a screen using a display and a warning alarm.
